(19) United States
(12) Patent Application Publication
(10) Pub. No.: US 2026/0341131 A1
(43) Pub. Date: Oct. 29, 2026

(54) LISTENING DEVICE WITH SMART MATERIAL INDICATION OF LISTENING STATE

(71) Applicant: Bang & Olufsen A/S, Struer (DK)

(72) Inventors: Magnus Søgaard MAGNUSSEN, Taastrup (DK); Jon FRANCOMBE, Struer (DK)

(21) Appl. No.: 19/654,394

(22) Filed: Apr. 21, 2026

(30) Foreign Application Priority Data
Apr. 25, 2025 (EP) 25172699.8

(51) Int. Cl. G08B 7/06; G08B 3/10; G08B 5/36; H04R 1/10

(52) U.S. Cl. CPC G08B 7/06; G08B 3/10; G08B 5/36; H04R 1/1008; H04R 1/1041; H04R 1/1083; H04R 2460/01

(57) ABSTRACT

Aspects provide a wearable audio device. The wearable audio device includes a smart material configured to change a level of optical transparency in response to a signal. The wearable audio device includes one or more transducers configured to produce sound. The wearable audio device includes one or more processors configured to control the signal to change the level of optical transparency of the smart material.

### CROSS-REFERENCE TO RELATED APPLICATION

This application claims priority to European Patent Application No. 25172699.8, filed April 25, 2025, which is incorporated by reference herein in its entirety.

### INTRODUCTION

### FIELD OF THE DISCLOSURE

The present disclosure is related to sound reproduction systems and, more specifically, to a listening device indicating a listening state.

### BACKGROUND

In today’s media-driven society, there are increasingly more ways for users to access video and audio, with a plethora of products producing sound in the home, car, or almost any other environment. Portable products producing audio, such as, for example, phones, tablets, laptops, headphones, portable loudspeakers, soundbars, and many other devices, are ubiquitous. The sound may include, for example, a large variety of audio such as music, speech, podcasts, sound effects, and audio associated with video content.

Audio technology generally encompasses systems and devices used to capture, process, transmit, and reproduce sound. Over the years, advances in audio technology have enabled higher fidelity sound reproduction, improved noise reduction techniques, and greater user convenience through wireless connectivity. From early analog devices to modern digital systems, audio technology has evolved to serve a variety of applications including consumer electronics, professional audio, telecommunications, and personal entertainment.

One significant category of audio devices is wearables, such as headphones which allow users to listen to audio privately. Headphones types may include over-ear headphones, in-ear headphones (earbuds), on-ear headphones, closed-back headphones, open-back headphones, and/or other types of headphones. Over-ear headphones have large ear cups that cover the entire ear and are typically connected to a headband. Over-ear headphones are often preferred for their comfort and ability to passively block external noise due to the physical coverage of the ear. In contrast, in-ear headphones, also called earbuds, fit directly into the ear canal and are favored for their compact size and portability. Both types of headphones may be designed as wired, using electrical cables to transmit audio signals from an audio source, or may be designed as wireless, utilizing radio frequency (RF) communication protocols such as Bluetooth to transmit audio signals without the need for physical cables. Wireless headphones may incorporate onboard batteries and controls to facilitate mobile and cordless operation.

Modern headphones may incorporate advanced listening modes to enhance the user experience in various environments. One such mode is active noise cancellation (ANC), which employs microphones and signal processing algorithms to detect ambient noise and generate an inverse sound wave to effectively reduce or cancel unwanted noise. Adaptive ANC adjusts the level of noise cancellation dynamically based on the detected external noise characteristics.

Another mode is passive listening. In the passive listening mode, external noise is attenuated due to the mechanical design (e.g., physical structure and materials) of the headphones, without active electronic processing. For example, wearable devices such as earbuds and closed-back headphones occlude the ear canal and pinna, respectively, but expose the transducer directly to the ear canal.

Yet another mode is transparency mode (also called ambient or aware mode) which allows external sounds to be intentionally passed through the headphones, often using external microphones to capture and mix ambient sounds into the audio playback. In transparency mode, the wearable device may selectively filter certain external sounds (e.g., ambient noise) in the user’s environment that is picked up by the microphone(s) of the wearable device. For example, the wearable device may digitally enhance certain sounds (e.g., speech), while still providing a level of noise cancellation for other sounds (e.g., ambient noise) in the user’s environment. Transparency mode enables users to remain aware of their surroundings while still listening to audio.

Additionally, certain wearable devices may support spatial audio, allowing a user to perceive sound as emanating from certain locations in three-dimensional (3D) space. Wearable devices that support spatial audio may employ spatial audio rendering algorithms to place virtual audio sources arbitrarily in the user’s environment. By arbitrarily placing virtual audio sources in the user’s environment, wearable devices can simulate a virtual acoustic environment, in which sounds appear to be externalized from the user’s head and can be localized in three dimensions. In some cases, wearable devices may support spatial audio with head tracking. For example, certain wearable devices may include inertial measurement unit (IMU) sensors, which can measure a user’s instantaneous head orientation in 3D (typically in terms of Heading, Pitch and Roll). Wearable devices may use this head orientation information to dynamically update a spatial audio rendering algorithm to give the impression that sounds remain fixed in space, relative to the external world.

Other listening modes may include an ambient sound listening mode, a talk-through listening mode (e.g., similar to a transparency mode, designed to allow human voices through), an adjustable noise cancelation listening mode (e.g., an adjustable ANC mode), a wind noise listening mode (e.g., focused on filtering or canceling wind noise), an equalization (EQ) listening mode (e.g., bass boost, treble boost, volume boost), a hearing enhancement listening mode (e.g., to aid hearing impaired listeners), a safety listening mode (e.g., limiting maximum volume to prevent hearing damage), a sleep mode (e.g., designed for bedtime to use by limiting to certain relaxing audio, volume reduction over time, and/or disabling certain features, audio, alerts, and/or notification), and a mix of listening modes.

As used herein, “ambient sound” may refer to any sound external to the wearable listening device. The listening state, or ability of a listener (or wearer of the wearable audio device) to hear ambient sounds, depends on the listening mode(s) activated on the wearable audio device. For example, while using an ANC mode the user may have very little ability to hear ambient sounds, whereas while using a passive listening mode the listener may have more ability to hear ambient sounds, and while using a transparency listening mode, the listener may have near complete ability to hear ambient sounds. Particular settings of these modes, volume levels, and other factors may also impact the listener’s ability to hear ambient sounds while using a wearable audio device. As used herein, “listening state” may refer to a listener’s ability to hear ambient sound.

It may be important for others, people not using the wearable audio device, to have information about the listener’s ability to hear ambient sounds. For example, it would be useful for a person to know if the listener will be able to hear them if they speak to them in order to determine whether and how to approach the listener to speak to them. As another example, for a driver of a vehicle it may be useful to know if the listener can hear ambient sounds, in order to judge the listener’s situational awareness. For example, the driver may be interested to know whether the listener will be able to hear the driver’s car approaching, or a honk of the horn, in order to help the driver make driving decisions around the listener such as to exercise heightened caution when the listener’s ability to hear ambient sound is reduced. As yet another example, it is important for emergency or security personnel to know whether a listener will be able to hear verbal commands, sirens, or other ambient sounds.

Accordingly, techniques and apparatus for indicating a listening state associated with a listener of an audio device are needed.

### SUMMARY

A wearable audio device is provided. The wearable audio device includes a smart material configured to change a level of optical transparency in response to a signal. The wearable audio device includes one or more transducers configured to produce sound. The wearable audio device includes one or more processors configured to control the signal to change the level of optical transparency of the smart material.

A method of indicating an ability of a wearer of a wearable audio device to hear ambient noise to a non-wearer of the wearable audio device is provided. The method includes outputting a signal to control a level of optical transparency of a smart material of the wearable audio device. The level of optical transparency of the smart material indicates the ability of the wearer of the wearable audio device to hear ambient noise.

A computer readable medium is provided. The computer readable medium includes computer executable code. The computer executable code includes code for outputting a signal to control a level of optical transparency of a smart material of a wearable audio device. The level of optical transparency of the smart material indicates an ability of a wearer of the wearable audio device to hear ambient noise.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 depicts an example system for indicating a listening state of a user of a wearable audio device, according to one or more aspects.

FIG. 2 depicts an example wearable audio device configured to indicate a listening state of a user of a wearable audio device with smart material ear cups, according to one or more aspects.

FIG. 3 depicts an example flow diagram for indicating a listening state of a user of a wearable audio device, according to one or more aspects.

FIG. 4 depicts an example wearable audio device configured to indicate inability of a user of a wearable audio device, in a noise cancelation listening mode, to hear ambient sound, according to one or more aspects.

FIG. 5 depicts an example wearable audio device configured to indicate ability of a user of a wearable audio device, in a transparency listening mode, to hear ambient sound, according to one or more aspects.

FIG. 6 depicts an example wearable audio device configured to indicate inability of a user of a wearable audio device, in a passive listening mode at high volume, to hear ambient sound, according to one or more aspects.

FIG. 7 depicts an example wearable audio device configured to indicate partial ability of a user of a wearable audio device, in a passive listening mode at intermediate volume, to hear ambient sound, according to one or more aspects.

FIG. 8 depicts an example wearable audio device configured to indicate ability of a user of a wearable audio device, in a passive listening mode at low volume, to hear ambient sound, according to one or more aspects.

FIG. 9 depicts an example wearable audio device configured to indicate a listening state of a user of a wearable audio device, according to one or more aspects.

### DETAILED DESCRIPTION

The present disclosure provides an approach for a wearable audio device indicating a listening state.

It should be understood that while aspects of the disclosure are described with respect to wearable audio devices, that the aspects described herein may be equally applicable to other types of audio devices such as loudspeakers.

In some aspects, a wearable audio is composed of a smart material configured to change a level of optical transparency to indicate the listening state. In some aspects, the control of the smart material may be done autonomously by the wearable device and/or by input from the wearer. In some aspects, the control of the smart material may be based on one or more configurable settings associating listening states with levels of optical transparency. In some aspects, when the listening state is associated with a lesser ability of the wearer to hear ambient sound, the smart material may be controlled to change to a lower level of optical transparency. In some aspects, when the listening state is associated with a greater ability of the wearer to hear ambient sound, the smart material may be controlled to change to a higher level of optical transparency. In some aspects, the listening state is based on one or more listening modes and/or parameters applied by the wearable audio deice.

Advantageously, aspects described herein can enable persons in the environment around the wearer of a wearable audio device to identify, based on the observed level of optical transparency of the smart material, the ability of the wearer to hear ambient sound.

### Example Audio Reproduction System

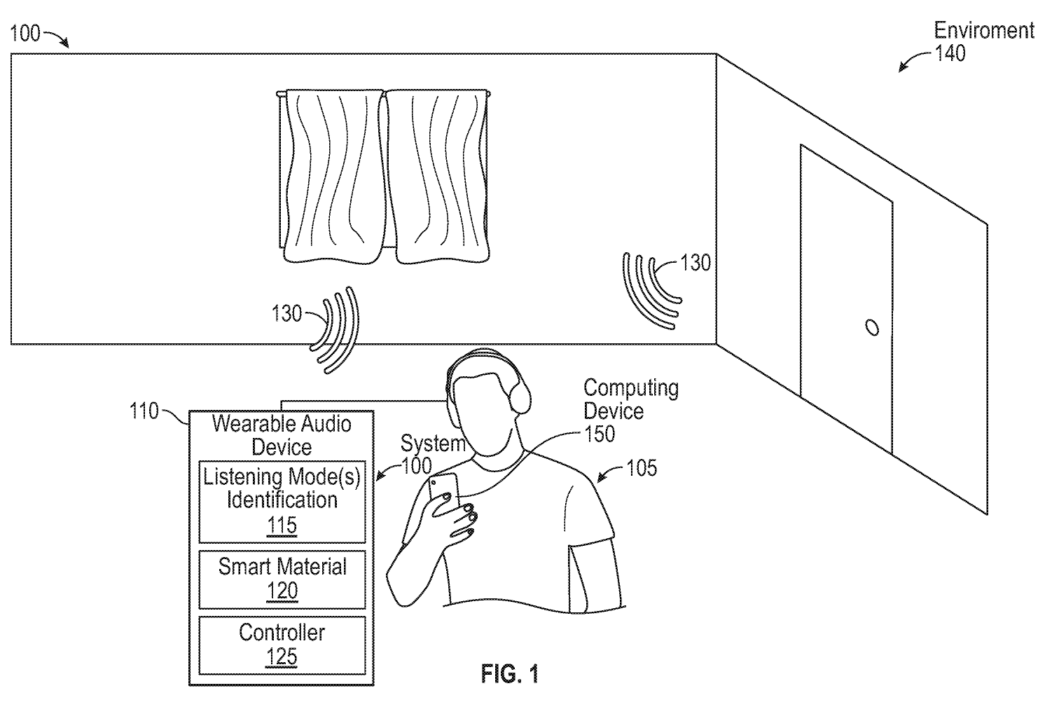

FIG. 1 depicts an example system 100 for indicating a listening state of a user 105 (e.g., a listener and/or wearer) of a wearable audio device 110, according to one or more aspects. The user 105 may operate the wearable audio device 110 within an environment 140, examples of which can include a workplace, residence, public facility, outdoors, etc.

The system 100 includes the wearable audio device 110. In some aspects, the user 105 wears the wearable audio device 110. In some aspects, the wearable audio device 110 is a pair of headphones. In some aspects, the wearable audio device 110 is over-ear headphones, in-ear headphones (earbuds), on-ear headphones, closed-back headphones, open-back headphones, and/or other types of headphones

In some aspects, the user 105 operates the wearable audio device 110 with a computing device 150. In some aspects, the computing device 150 may be representative of a variety of computing devices including, but not limited to, a smartphone, a tablet, a laptop computer, a gaming console, a smartwatch, a smart television, or other computing device.

The wearable audio device 110 may be communicatively coupled to the computing device 150 via a wireless communication link (e.g., Bluetooth communication link or another wireless protocol) or a wired communication link (e.g., via a headphone cable). The user 105 may use the wearable audio device 110 to listen to audio content (e.g., music, audio podcast, video content, voice calls, video calls, games, etc.) from the computing device 150. Note that while FIG. 1 illustrates the wearable audio device 110 as separate from the computing device 150, in certain aspects, the computing device 150 is integral with the wearable audio device 110.

In some aspects, a wearable audio device receives audio content via one or more sources. For example, the source(s) may include a digital media source, such as a software application running on the user’s computing device. For example, the digital media source may transmit audio content from the user’s computing device to the wearable device over a communication link (e.g., wireless communication link or wired communication link) between the wearable audio device and the user’s computing device. In some aspects, the source(s) includes an ambient environment in which the user is located. For example, microphone(s) of the wearable device may capture external sounds (e.g., ambient sounds, white noise, voice traffic) that are present in the user’s environment. In yet another example, the source(s) includes a combination of a digital media source and an ambient environment. For example, the wearable audio device may receive (i) first audio content (e.g., music) from a music streaming application on the user’s computing device via a communication link between the wearable device and the user’s computing device and (ii) second audio content (e.g., ambient sounds) from the user’s environment via microphone(s) of the wearable device.

The wearable audio device 110 may support multiple listening modes for listening to audio content, including, for example, active noise cancellation listening mode, transparency listening mode, passive listening mode, spatial audio mode, head-tracking mode, ambient sound mode, talk-though listening mode, adjustable noise cancelation listening mode, a wind noise listening mode, an EQ listening mode, a hearing enhancement listening mode, a safety listening mode, a sleep mode, or a mix of listening modes.

In some aspects, the user 105 is able to select the listening mode(s). For example, the user 105 may be able to pre-configure listening mode preferences, use a verbal command, a gesture, or the computing device 150 to select the listening mode(s). In some aspects, the wearable audio device 110 and/or computing device 150 may autonomously select the listening mode(s). For example, the wearable audio device 110 and/or computing device 150 may be configured with settings, rule based logic, machine learning, predefined events, triggers, time periods, etc., for dynamically selecting the listening mode(s).

As shown in the FIG. 1, the environment 140 may include ambient sound 130. As discussed herein, ambient noise may include any noise external the wearable audio device 110, such as voices, wind, cars, animals, or any other sound. The user 105 ability to hear the ambient sound 130 may be dependent on the listening mode(s) active on the wearable audio device 110.

According to certain aspects, the wearable audio device 110 includes a listening mode(s) identification component 115 configured to identify (e.g., determine, detect) the listening mode(s) currently in use on the wearable audio device 110.

According to certain aspects, the wearable audio device 110 includes smart material 120. As used herein, smart material may refer to any material capable of being controlled to adjust an optical transparency or optical opaqueness of the material. In some aspects, the smart material 120 may be smart glass, smart film, a smart acrylic, an electrochromic material (e.g., material that changes tint when an electric voltage is applied), a thermochromic material (e.g., a material that changes tint based on temperature), a photochromic material (e.g., a material that reacts to ultraviolet light), a liquid crystal film, or a suspended particle film (e.g., material that uses microscopic particles suspended in liquid, when electricity is applied the particles align to allow light to pass through).

In some aspects, one or more components of the wearable audio device 110 may be comprised of the smart material 120. As one example, a portion of the frame body of the wearable audio device 110 and/or of the ear cups of the wearable audio device 110 may be made of the smart material such that, when optically transparent, the interior of the wearable audio device 110 is visible to persons in the environment 140. For example, when the smart material 120 is optically transparent, interior components of the wearable audio device 110 may be visible to persons in the environment 140. In another example, when the smart material 120 is optically transparent, biological (or anatomical) features of the user 105 (e.g., such as the user’s ears) may be visible to persons in the environment 140. Alternatively, when the smart material 120 is optically opaque, the interior components of the wearable audio device 110 and/or biological (or anatomical) features of the user 105 are not visible to persons in the environment 140. In some aspects, the smart material 120 can have more states than optically transparent or optically opaque, for example, the smart material 120 can have various levels of optical translucence (e.g., blurry) to indicate varying listening states.

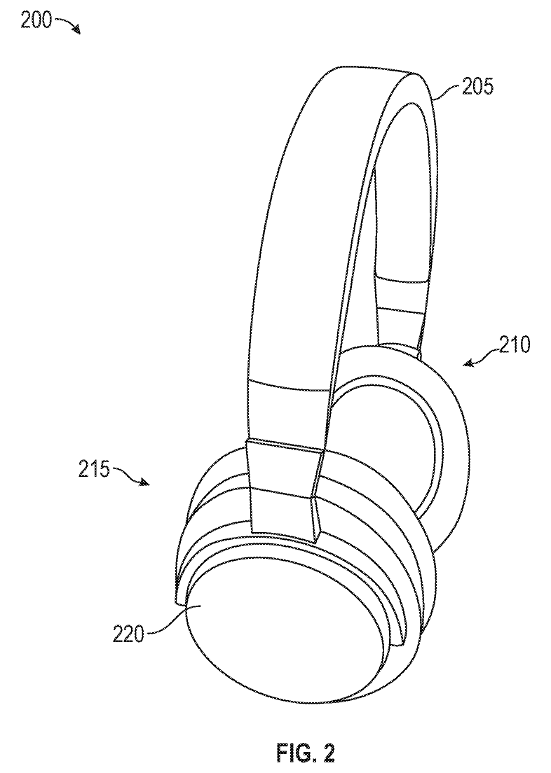

FIG. 2 depicts an illustrative example of a wearable audio device configured to indicate a listening state, according to one or more aspects. In FIG. 2, the wearable audio device is a pair of over-the-ear headphones 200. As shown, the headphones 200 may include a frame 205 configured to comfortably secure the headset to a wearer of the headphones 200. As shown, the headphones 200 include ear cups 210 and 215. In some aspects, within the ear cups 210 and 215 may be included additional components (not shown) such as processors, transducers, padding, a driver, a light source, an antenna, a battery, a printed circuit board (PCB), and/or other components of the headphones 200. As shown, in the illustrative example, a portion of the ear cups 210 and 215 are composed of smart material 220. The portion with the smart material 220 may form a substantial portion of the ear cups 210 and 215, such that when the smart material 220 is optically transparent, components of the inner structure of the headphones 200 are clearly visible through the ear cups 210 and 215.

It should be understood that FIG. 2 is merely one example implementation of a wearable audio device, but that other audio devices than headphones may be used, and that other implementations of headphones may be used, including with different placements of the smart material 220. For example, the smart material 200 may be included on a different portion of the ear cups 210 and 215, or on a different portion or component of the headphones 200.

Returning to FIG. 1, in some aspects, the wearable audio device 110 further includes a light source configured to illuminate the one or more internal components of the wearable audio device 110 or the one or more biological (or anatomical) features of the wearer 105 of the wearable audio device 110. In some aspects, the light source is configured to turn on in response to, or in combination with, the smart material 120 being changed to the higher level of optical transparency. In some aspects, the light source may be configured to turn on in response to low light ambient conditions.

Accordingly, a person in the environment 140 can observe the level of transparency of the smart material 120 on the wearable audio device 110 and easily identify the listening state of the user 105 based on the level of transparency.

In some aspects, the smart material 120 is configured to change its level of optical transparency or opaqueness in response to a signal. In some aspects, the signal may be an electrical signal, an optical signal, or a thermal signal.

According to certain aspects, the wearable audio device 110 includes a controller 125. In some aspects, the controller 125 is configured to control the smart material 120 in response to the identification of the listening mode(s). In some aspects, the controller 125 is further configured to control the light source.

In a simple illustrative example, when the wearable audio device 110 is in an ANC mode, smart material 120 on the ear cups of the wearable audio device 110 is switched to optically opaque (diffused, or blurry), such that the wearer’s ear are not visible through the wearable audio device 110. When the wearable audio device 110 is in a transparency mode, the smart material 120 on the ear cups of the wearable audio device 110 is switched to optically transparent such that the wearer’s ears are visible through the wearable audio device 110.

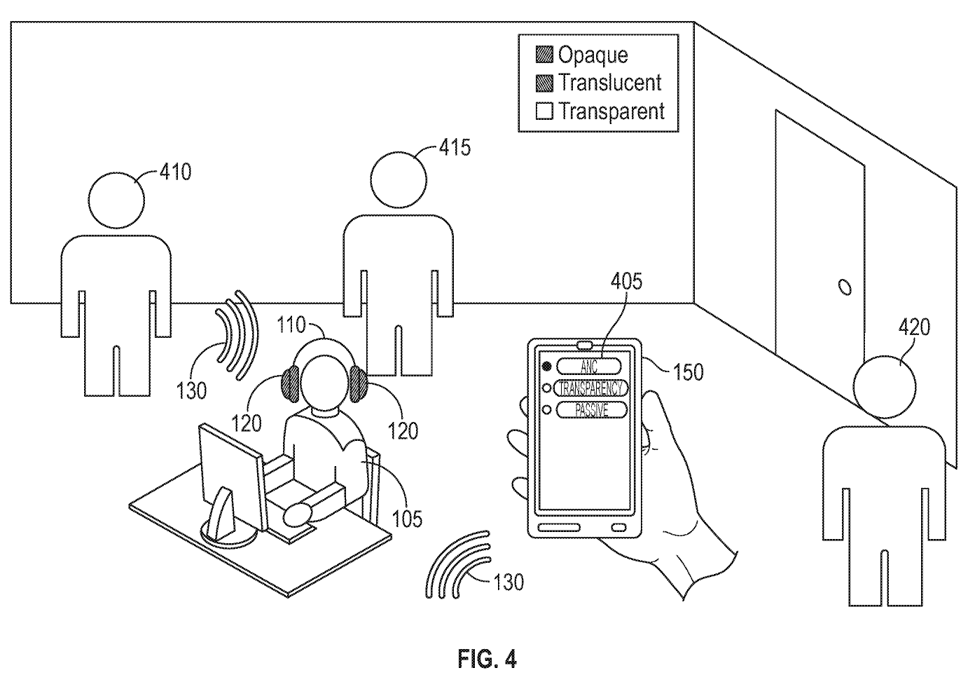

Note that while FIG. 1, and FIGS. 4-7 below, describe the system 100 being used within an indoor environment 140, the system 100 as well as the techniques described herein for indicating a listening state of a user of a wearable device can be implemented in outdoor environments (e.g., park, city street, neighborhood). Further, note that while FIG. 1, and FIGS. 4-7 depict the listening mode(s) identification component 115 and the controller 125 of the smart material 120 being implemented on the wearable audio device 110, in other aspects, the listening mode(s) identification component 115 and the controller 125 of the smart material 120 may be implemented on another device, such as the computing device 150 or another external device. In such aspects, the wearable audio device 110 can send sensor data from one or more sensors (e.g., accelerometers, gyroscopes, and magnetometers) of the wearable audio device 110 to the computing device 150.

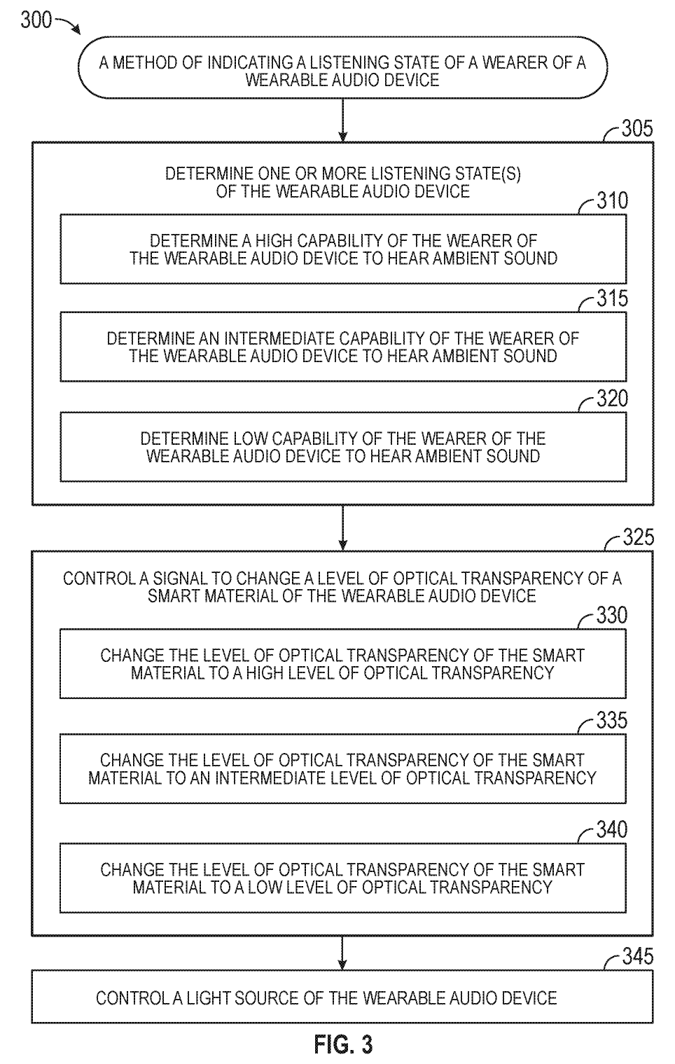

FIG. 3 depicts an example flow diagram of operations 300 for indicating a listening state of a user (e.g., such as the user 105) of a wearable audio device (e.g., such as a wearable audio device 110), according to one or more aspects.

The operations 300 may be understood with reference to the FIGS. 1, 2, and 4-8. The operations 300 may be performed by one or more processors of a wearable audio device. The one or more processors may be located within the wearable audio device, may be located remotely (e.g., in a connected device or in a cloud) from the wearable audio device. In some aspects, the operations 300 may be performed by the controller 125, the processors 905, or another processor.

Operations 300 may begin, at operation 305, with determining a listening state of the wearable audio device. In some aspects, determining the listening state at operation 305 may include determining one or more (active) listening modes of the wearable audio device. In some aspects, the listening state may be one of multiple different listening states. In some aspects, the listening states are associated with different capabilities of a wearer of the wearable audio device to hear ambient sound. In some aspects, the listening state is based on an active noise cancelation listening mode, a transparency listening mode, a passive listening mode, a mixed listening mode, a power on mode, a power off mode, an audio playing mode, an audio not playing mode, an audio paused mode, an audio muted mode, a volume level being above one or more thresholds, and/or a volume level being below one or more thresholds.

As shown, determining the listening state of the wearable audio device, at operation 305, may include determining, at operation 310, one or more listening modes associated with a high capability of the wearer of the wearable audio device to hear ambient sound. For example, the determining, at operation 310, the high capability of the wearer of the wearable audio device to hear ambient sound may be in response to determining, at operation 305, a transparency listening mode, a passive listening mode, a mixed listening mode, a power off mode, an audio not playing mode, an audio paused mode, an audio muted mode, and/or a volume level being below one or more thresholds.

As shown, determining the listening state of the wearable audio device, at operation 305, may include determining, at operation 315, one or more listening modes associated with an intermediate capability of the wearer of the audio device to hear ambient sound. For example, the determining, at operation 315, the intermediate capability of the wearer of the wearable audio device to hear ambient sound may be in response to determining the one or more listening modes, at operation 305, is a passive listening mode, a mixed listening mode, and/or a volume level being within one or more thresholds.

As shown, determining the listening state of the wearable audio device, at operation 305, may include determining, at operation 320, one or more listening modes associated with a low capability of the wearer of the audio device to hear ambient sound. For example, the determining, at operation 320, the low capability of the wearer of the wearable audio device to hear ambient sound may be in response to determining the one or more listening modes, at operation 305, is an active noise cancelation mode, a passive listening mode, a power on mode, an audio playing mode, and/or a volume level being above one or more thresholds.

In some aspects, an association between the listening modes and the capability of the wearer of the wearable audio device to hear ambient sound are pre-configured. For example, the association between the listening modes and the capability of the wearer of the wearable audio device to hear ambient sound may be pre-programmed, specified by a user or operator, based on one or more rules, and/or learned based on the user feedback.

Operations 300 may include, at operation 325, controlling a signal to change a level of optical transparency of a smart material of the wearable audio device. In some aspects, the signal may be an electrical signal, a thermal signal, or a light signal.

In some aspects, the controlling the signal, at operation 325, is based on the one or more listening modes determined at operation 305. In some aspects, the controlling the signal, at operation 325, is performed autonomously and/or automatically by one or more processors of the wearable audio device.

In some aspects, the wearable audio device receives an input from a user interface of the wearable audio device indicating the level of optical transparency. For example, the wearer of the wearable audio device may select the level of optical transparency via a physical control (e.g., a button, knob, switch, or other physical controller) of the wearable audio device or via a computing device (e.g., via an application running on a computing device associated with the wearable audio device). For example, the wearer may select the level of optical transparency via an application (or other software program) from a user device (e.g., such as a smart phone, computer, tablet, smart watch, virtual assistant, or other user device). In some aspects, the controlling the signal, at operation 325, is based on the input from the user interface.

In some aspects, an association between the listening states and levels of optical transparency are pre-configured. For example, the association between the listening states and the level of optical transparency of the smart material may be pre-programmed, specified by a user or operator, based on one or more rules, and/or learned based on the user feedback. In some aspects, controlling the level of optical transparency of the smart material, at operation 325, is based on the pre-configured association between the determined listening state and the associated level of optical transparency.

In some aspects, controlling the level of optical transparency of the smart material, at operation 325, includes controlling, at operation 330, the signal to change the level of optical transparency of the smart material to a high level of optical transparency. In some aspects, the controlling, at operation 330, the signal to change the level of optical transparency of the smart material to the high level of optical transparency may be in response to determining the listening mode, at operation 310, is associated with the high capability of the wearer of the wearable audio device to hear ambient sound.

In some aspects, the higher level of optical transparency comprises a fully optically transparent or substantially optically transparent level of optical transparency. In some aspects, the smart material, when changed to the high level of optical transparency, provides a view of one or more internal components of the wearable audio device or one or more biological (or anatomical) features of a wearer of the wearable audio device. In some aspects, the one or more biological (or anatomical) features includes one or more ears of the wearer of the wearable audio device. In some aspects, the one or more internal components include at least one of: at least one of the one or more transducers, a battery, an antenna, or a printed circuit board within the wearable audio device.

In some aspects, controlling the level of optical transparency of the smart material, at operation 325, includes controlling, at operation 335, the signal to change the level of optical transparency of the smart material to an intermediate level of optical transparency. In some aspects, the controlling, at operation 335, the signal to change the level of optical transparency of the smart material to the intermediate level of optical transparency may be in response to determining the listening mode, at operation 315, is associated with the intermediate capability of the wearer of the wearable audio device to hear ambient sound. In some aspects, the intermediate level of optical transparency may include an optically translucent or optically blurry level of transparency.

In some aspects, controlling the level of optical transparency of the smart material, at operation 325, includes controlling, at operation 340, the signal to change the level of optical transparency of the smart material to a low level of optical transparency. In some aspects, the controlling, at operation 340, the signal to change the level of optical transparency of the smart material to the low level of optical transparency may be in response to determining the listening mode, at operation 320, is associated with the low capability of the wearer of the wearable audio device to hear ambient sound. In some aspects, the low level of optical transparency includes a fully optically opaque, a substantially optically opaque, or a blurry level of optical transparency.

In some aspects, the operations 300 further include, at operation 345, controlling a light source of the wearable audio device.

FIG. 4 depicts an example wearable audio device 110 configured to indicate a listening state of a user of a wearable audio device, according to one or more aspects. As shown, the user 105 of the wearable audio device 110 may operate the computing device 150 to select an ANC listening mode 405. In this case, the user 105 may not be capable of hearing ambient sound 130. In the illustrated example, the smart material 120 of the wearable audio device 110 is changed to be optically opaque. Thus, the persons 410, 415, and 420 near the user 105 may be able to see that the wearable audio device 110 is optically opaque and identify that the user 105 is not capable of hearing ambient sound 130.

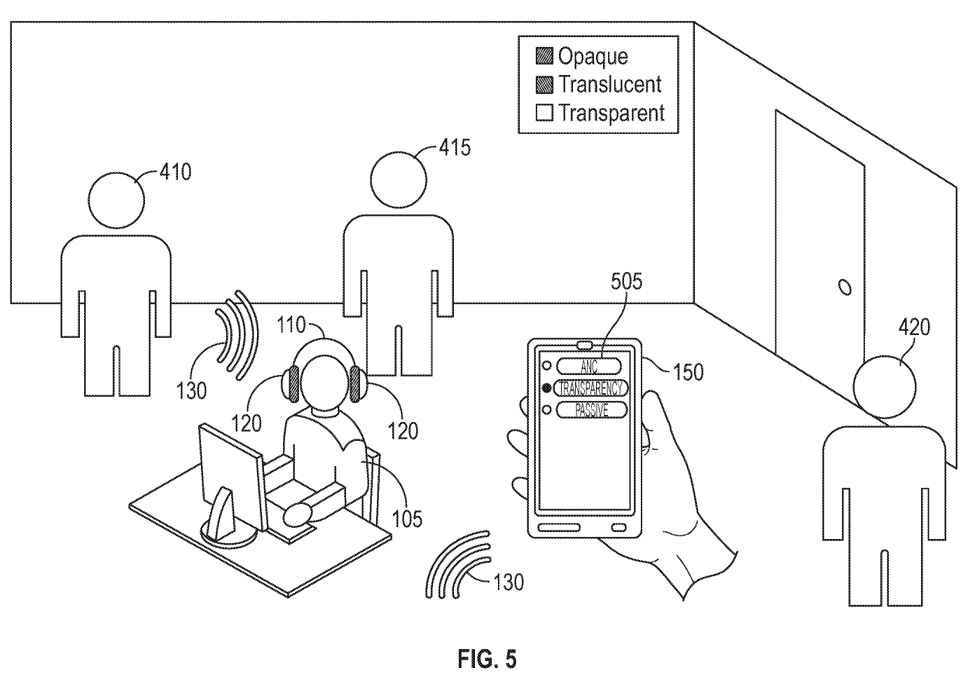

FIG. 5 depicts another example wearable audio device 110 configured to indicate a listening state of the user of a wearable audio device, according to one or more aspects. As shown, the user 105 of the wearable audio device 110 may operate the computing device 150 to select a transparency listening mode 505. In this case, the user 105 may be capable of hearing ambient sound 130. In the illustrated example, the smart material 120 of the wearable audio device 110 is changed to be optically transparent. Thus, the persons 410, 415, and 420 near the user 105 may be able to see that the wearable audio device 110 is optically transparent and identify that the user 105 is capable of hearing ambient sound 130.

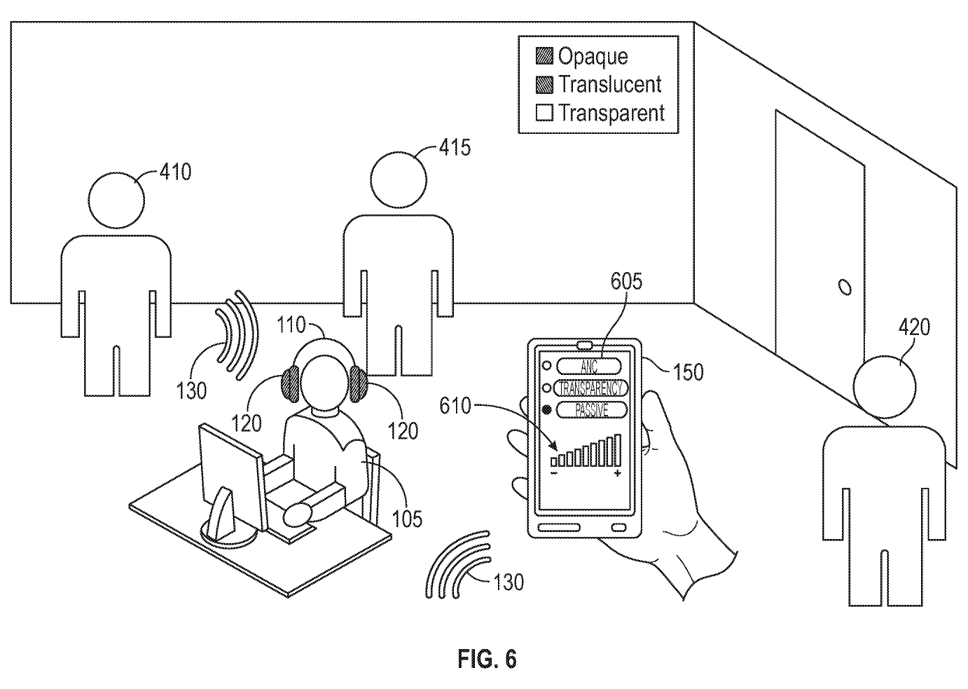

FIG. 6 depicts another example wearable audio device 110 configured to indicate a listening state of the user of a wearable audio device, according to one or more aspects. As shown, the user 105 of the wearable audio device 110 may operate the computing device 150 to select a passive listening mode 605 with a high volume level 610. In this case, the user 105 may be incapable of hearing ambient sound 130. In the illustrated example, the smart material 120 of the wearable audio device 110 is changed to be optically opaque. Thus, the persons 410, 415, and 420 near the user 105 may be able to see that the wearable audio device 110 is optically opaque and identify that the user 105 is incapable of hearing ambient sound 130.

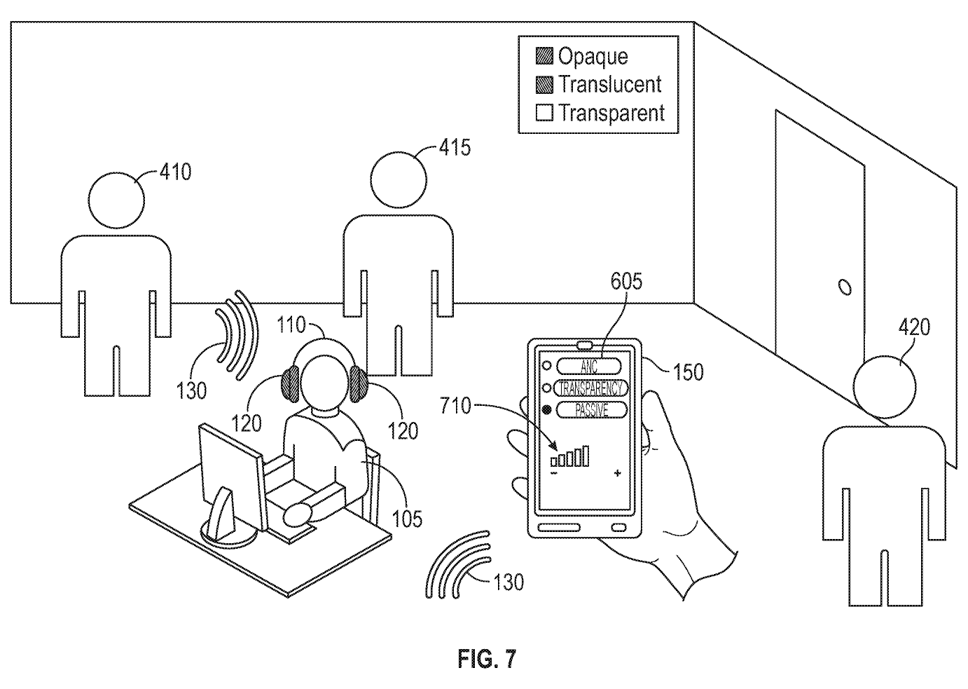

FIG. 7 depicts another example wearable audio device 110 configured to indicate a listening state of the user of a wearable audio device, according to one or more aspects. As shown, the user 105 of the wearable audio device 110 may operate the computing device 150 to select the passive listening mode 605 with an intermediate volume level 710. In this case, the user 105 may be partially capable of hearing ambient sound 130. In the illustrated example, the smart material 120 of the wearable audio device 110 is changed to be optically translucent or blurry. Thus, the persons 410, 415, and 420 near the user 105 may be able to see that the wearable audio device 110 is optically translucent or blurry and identify that the user 105 is only partially capable of hearing ambient sound 130.

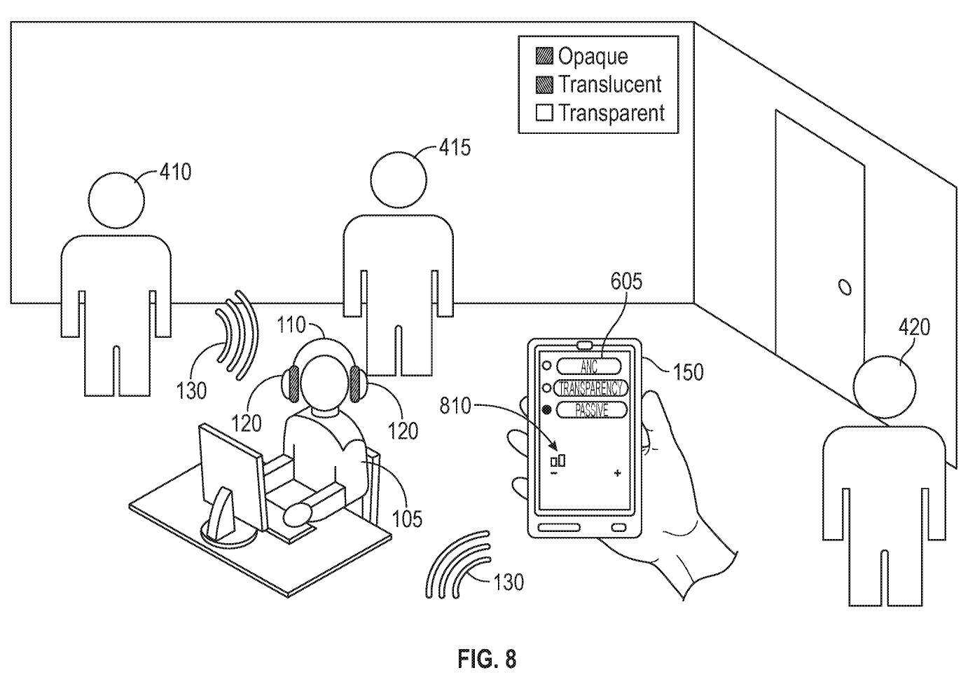

FIG. 8 depicts another example wearable audio device 110 configured to indicate a listening state of the user of a wearable audio device, according to one or more aspects. As shown, the user 105 of the wearable audio device 110 may operate the computing device 150 to select the passive listening mode 605 with a low volume level 810. In this case, the user 105 may be capable of hearing ambient sound 130. In the illustrated example, the smart material 120 of the wearable audio device 110 is changed to be optically transparent. Thus, the persons 410, 415, and 420 near the user 105 may be able to see that the wearable audio device 110 is optically transparent and identify that the user 105 is capable of hearing ambient sound 130.

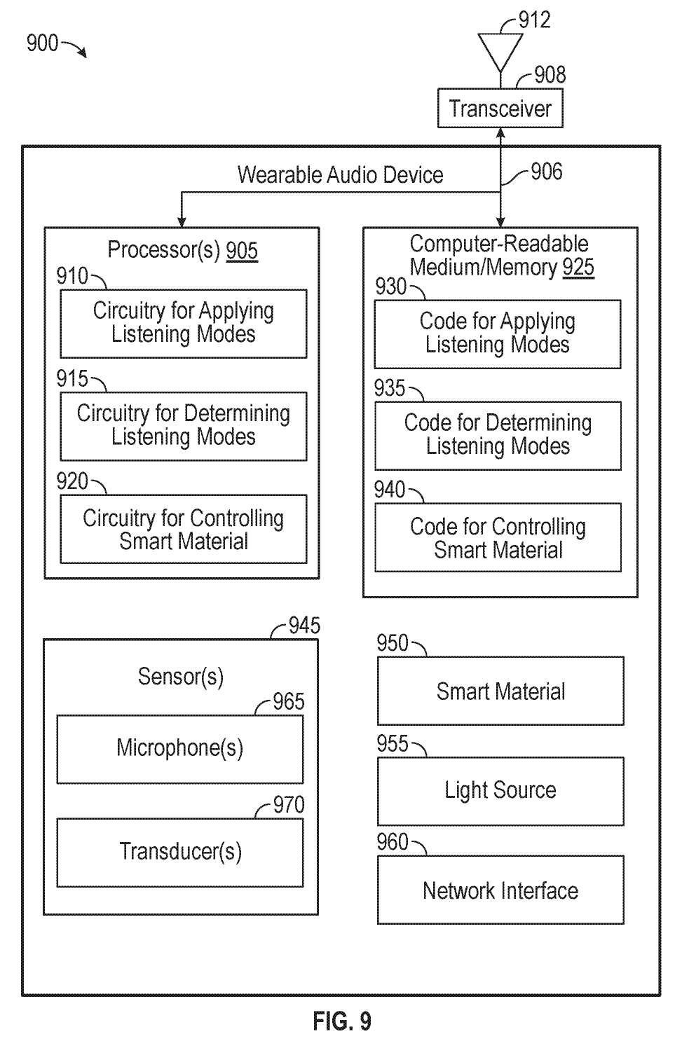

FIG. 9 depicts an example wearable audio device 900 (e.g., such as wearable audio device 110) configured to indicate a listening state of a user of a wearable audio device, according to one or more aspects. While shown as a single device, in some aspects, components of wearable audio device 900 may be implemented across multiple physical devices within a system and/or within a network, such as by server within a network.

The wearable audio device 900 may include one or more processors 905 coupled to a transceiver 908 (e.g., a transmitter and/or a receiver). The transceiver 908 is configured to transmit and receive signals for the wearable audio device 900 via an antenna 912, such as the various signals as described herein. The one or more processors 905 may be configured to perform processing functions for the wearable audio device 900. The wearable audio device 900 may include a network interface 960. The network interface 960 may be any type of wired or wireless network communications interface that allows the wearable audio device 900 to communicate with other computers and/or components in the system via a data communications network. In one particular aspect, the network interface 960 is a Bluetooth communications interface that allows the wearable audio device 900 to wirelessly communicate with a computing device (e.g., computing device 150) over a Bluetooth communication link. In another embodiment, the network interface 960 is a wired communications interface, such as a headphone cable.

The wearable audio device 900 includes one or more processors 905. A processor 905 represents any number of processing elements, which can include any number of processing cores. The one or more processors 905 include circuitry configured to implement (e.g., execute) the aspects described herein for indicating a listening state, including circuitry for applying one or more listening modes 910, circuitry for determining the one or more listening modes 915, and/or circuitry for controlling smart material 920. Processing with circuitry 910-920 may cause the wearable audio device 900 to perform the operations 300 described with respect to FIG. 3, or any aspect related to it.

The one or more processors 905 are coupled to a computer-readable medium/memory 925 via a bus 906. The computer-readable medium/memory 925 can include volatile memory, non-volatile memory, and combinations thereof. In certain aspects, the computer-readable medium/memory 925 is configured to store instructions (e.g., computer-executable code) that when executed by the one or more processors 905, cause the one or more processors 905 to perform the operations 300 described with respect to FIG. 3, or any aspect related to it. Note that reference to a processor performing a function of wearable audio device 900 may include one or more processors performing that function of wearable audio device 900. In the depicted example, computer-readable medium/memory 925 stores code (e.g., executable instructions) for applying one or more listening modes 930, code for determining the one or more listening modes 935, and code for controlling a smart material 940.

As shown, the wearable audio device 900 may include one or more sensors 945. In some aspects, the one or more sensors 945 includes one or more microphones 965 and one or more transducers 970. The one or more microphones 965 are generally transducers that converts sound into an electrical signal. Here, for example, the one or more microphones 965 can capture external sound (e.g., external ambient sounds 130), convert the external sound into electrical signals, and provide the electrical signals to the wearable audio device 900 for processing. In some aspects, the wearable audio device 900 includes multiple microphones 965 (e.g., one microphone 965 for the portion of the wearable audio device 900 used for the left ear of a listener and another microphone 965 for the portion of the wearable audio device 900 used for the right ear of the listener). The one or more transducers 970 are generally electroacoustic transducers that convert electrical signals to acoustic signals. For example, a transducer 970 may receive an electrical signal(s), convert the electrical signal(s) into acoustic signals, and may output or provide the acoustic signals to a listener’s ear canals. In some aspects, wearable audio device 900 includes multiple transducers 970 (e.g., one transducer 970 for the user’s left ear and another transducer 970 for the user’s right ear).

As shown, the wearable audio device 900 includes smart material 950. The smart material 950 may include any smart material discussed herein (e.g., smart material 120) configured to change its level of optical transparency. The smart material 950 may be integrated with or located on any portion of the wearable audio device 900, for example, in accordance with aspects described herein.

As shown, the wearable audio device 900 may include a light source 955. The light source 955 may include any light source, for example, a light emitting diode (LED). The light source 955 may be configured to illuminate a portion of the wearable audio device 900 in connection with the smart material 950, in accordance with aspects described herein.

### Example Aspects

In addition to the various aspects described above, specific combinations of aspects are within the scope of the disclosure, some of which are detailed below:

Aspect 1: A wearable audio device, comprising: a smart material configured to change a level of optical transparency in response to a signal; one or more transducers configured to produce sound; and one or more processors configured to control the signal to change the level of optical transparency of the smart material.

Aspect 2: The wearable audio device of Aspect 1, wherein the smart material comprises smart glass, a smart acrylic, an electrochromic material, a thermochromic material, a photochromic material, a liquid crystal film, or a suspended particle film.

Aspect 3: The wearable audio device of Aspects 1 or 2, wherein the one or more processors are configured to: determine a listening state; and control, based on the determined listening state, the signal to change the level of optical transparency of the smart material.

Aspect 4: The wearable audio device of Aspect 3, wherein the listening states comprises one of a plurality of listening states, and wherein the plurality of listening states are associated with different capabilities of a wearer of the wearable audio device to hear ambient sound.

Aspect 5: The wearable audio device of Aspect 4, wherein an association between the plurality of listening states and levels of optical transparency are pre-configured, and wherein the one or more processors are configured to control the signal to change the level of optical transparency of the smart material based on the pre-configured association between the determined listening state and the associated level of optical transparency.

Aspect 6: The wearable audio device of any combination of Aspects 3-5, wherein the one or more processors are configured to determine the listening state based on at least one of: an active noise cancelation listening mode, a transparency listening mode, a passive listening mode, a mixed listening mode, a power on mode, a power off mode, an audio playing mode, an audio not playing mode, an audio paused mode, an audio muted mode, a volume level being above one or more thresholds, or a volume level being below one or more thresholds.

Aspect 7: The wearable audio device of any combination of Aspects 3-5, wherein the one or more processors are configured to control the signal to change the level of optical transparency of the smart material to a higher level of optical transparency, and wherein the determined listening state is associated with a higher capability of the wearer of the wearable audio device to hear ambient sound.

Aspect 8: The wearable audio device of Aspect 7, wherein the listening state associated with the higher capability of the wearable audio device to hear ambient sound is based on at least one of: a transparency listening mode, a passive listening mode, a mixed listening mode, a power off mode, an audio not playing mode, an audio paused mode, an audio muted mode, or a volume level being below one or more thresholds.

Aspect 9: The wearable audio device of Aspects 7 or 8, wherein the higher level of optical transparency comprises a fully optically transparent or substantially optically transparent level of optical transparency.

Aspect 10: The wearable audio device of any combination of Aspects 7-9, wherein the smart material, when changed to the higher level of optical transparency, provides a view of one or more internal components of the wearable audio device or one or more biological or anatomical features of a wearer of the wearable audio device.

Aspect 11: The wearable audio device of Aspect 10, wherein the one or more biological or anatomical features comprise one or more ears of the wearer of the wearable audio device.

Aspect 12: The wearable audio device of Aspects 10 or 11, wherein the one or more internal components comprise at least one of: at least one of the one or more transducers, a battery, an antenna, or a printed circuit board of the wearable audio device.

Aspect 13: The wearable audio device of any combination of Aspects 10-12, further comprising a light source configured to illuminate the one or more internal components of the wearable audio device or the one or more biological or anatomical features of the wearer of the wearable audio device.

Aspect 14: The wearable audio device of any combination of Aspects 3-13, wherein the one or more processors are configured to control the signal to change the level of optical transparency of the smart material to a lower level of optical transparency, and wherein the determined listening state is associated with a lower capability of the wearer of the wearable audio device to hear ambient sound.

Aspect 15: The wearable audio device of Aspect 14, wherein the listening state associated with the lower capability of the wearer of the wearable audio device to hear ambient sound is based on at least one of: an active noise cancelation listening mode, a passive listening mode, a mixed listening mode, a power on mode, an audio playing mode, or a volume level being above one or more thresholds.

Aspect 16: The wearable audio device of Aspects 14 or 15, wherein the lower level of optical transparency comprises a fully optically opaque or a substantially optically opaque level of optical transparency.

Aspect 17: The wearable audio device of any combination of Aspects 3-16, wherein the one or more processors are configured to control the signal to change the level of optical transparency of the smart material to an intermediate level of optical transparency, and wherein the determined listening state is associated with an intermediate capability of the wearer of the wearable audio device to hear ambient sound.

Aspect 18: The wearable audio device of Aspect 17, wherein the listening state associated with the intermediate capability of the wearer of the wearable audio device to hear ambient sound is based on at least one of: a passive listening mode, a mixed listening mode, a power on mode, an audio playing mode, or a volume level satisfying one or more thresholds.

Aspect 19: The wearable audio device of Aspects 17 or 18, wherein the intermediate level of optical transparency comprises an optically translucent or blurry level of optical transparency.

Aspect 20: The wearable audio device of any combination of Aspects 1-18, wherein the one or more processors configured to: receive an input via a user interface indicating the level of optical transparency; and control the signal to change the level of optical transparency of the smart material based on the input.

Aspect 21: The wearable audio device of any combination of Aspects 1-20, wherein the wearable audio device comprises headphones.

Aspect 22: The wearable audio device of any combination of Aspects 1-22, further comprising one or more ear cups configured to enclose at least a portion of at least one ear of a wearer of the wearable audio device, wherein at least a portion of the one or more ear cups comprises the smart material.

Aspect 23: An apparatus comprising means for indicating a listening mode of a wearable audio device in accordance with any of Aspects 1-22.

Aspect 24: A computer-readable medium comprising executable instructions that, when executed by one or more processors of an apparatus, cause the apparatus to indicate a listening mode of a wearable audio device in accordance with any of Aspects 1-22.

Aspect 25: A computer program product embodied on a computer-readable storage medium comprising code for indicating a listening mode of a wearable audio device in accordance with any of Aspects 1-22.

Aspect 26: An apparatus comprising: a memory comprising executable instructions and one or more processors configured to execute the executable instructions and cause the apparatus to indicate a listening mode of a wearable audio device in accordance with any of Aspects 1-22.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an application-specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The present aspects may be a system, a method, and/or a computer program product. The computer program product may include a computer-readable storage medium (or media) having computer-readable program instructions thereon for causing a processor to carry out aspects of the present invention. The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the "C" programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some aspects, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Computer-readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. §112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

We claim:

1. A wearable audio device, comprising:
a smart material configured to change a level of optical transparency in response to a signal;
one or more transducers configured to produce sound; and
one or more processors configured to control the signal to change the level of optical transparency of the smart material.

2. The wearable audio device of claim 1, wherein the smart material comprises smart glass, a smart acrylic, an electrochromic material, a thermochromic material, a photochromic material, a liquid crystal film, or a suspended particle film.

3. The wearable audio device of claim 1, wherein the one or more processors are configured to:
determine a listening state; and
control, based on the determined listening state, the signal to change the level of optical transparency of the smart material.

4. The wearable audio device of claim 3, wherein the listening states comprises one of a plurality of listening states, and wherein the plurality of listening states are associated with different capabilities of a wearer of the wearable audio device to hear ambient sound.

5. The wearable audio device of claim 3, wherein the one or more processors are configured to determine the listening state based on at least one of: an active noise cancelation listening mode, a transparency listening mode, a passive listening mode, a mixed listening mode, a power on mode, a power off mode, an audio playing mode, an audio not playing mode, an audio paused mode, an audio muted mode, a volume level being above one or more thresholds, or a volume level being below one or more thresholds.

6. The wearable audio device of claim 3, wherein the one or more processors are configured to control the signal to change the level of optical transparency of the smart material to a higher level of optical transparency in response to determining the listening state associated with a higher capability of a wearer of the wearable audio device to hear ambient sound, and wherein the listening state associated with the higher capability of the wearable audio device to hear ambient sound is based on at least one of: a transparency listening mode, a passive listening mode, a mixed listening mode, a power off mode, an audio not playing mode, an audio paused mode, an audio muted mode, or a volume level being below one or more thresholds.

7. The wearable audio device of claim 6, wherein the higher level of optical transparency comprises a fully optically transparent or substantially optically transparent level of optical transparency.

8. The wearable audio device of claim 6, wherein the smart material, when changed to the higher level of optical transparency, provides a view of one or more internal components of the wearable audio device or one or more biological or anatomical features of a wearer of the wearable audio device.

9. The wearable audio device of claim 8, further comprising a light source configured to illuminate the one or more internal components of the wearable audio device or the one or more biological or anatomical features of the wearer of the wearable audio device.

10. The wearable audio device of claim 3, wherein:
the one or more processors are configured to control the signal to change the level of optical transparency of the smart material to a lower level of optical transparency, wherein the determined listening state is associated with a lower capability of a wearer of the wearable audio device to hear ambient sound;
the listening state associated with the lower capability of the wearer of the wearable audio device to hear ambient sound is based on at least one of: an active noise cancelation listening mode, a passive listening mode, a mixed listening mode, a power on mode, an audio playing mode, or a volume level being above one or more thresholds; and
the lower level of optical transparency comprises a fully optically opaque or a substantially optically opaque level of optical transparency.

11. The wearable audio device of claim 3, wherein:
the one or more processors are configured to control the signal to change the level of optical transparency of the smart material to an intermediate level of optical transparency, wherein the determined listening state is associated with an intermediate capability of a wearer of the wearable audio device to hear ambient sound;
the listening state associated with the intermediate capability of the wearer of the wearable audio device to hear ambient sound is based on at least one of: a passive listening mode, a mixed listening mode, a power on mode, an audio playing mode, or a volume level satisfying one or more thresholds; and
the intermediate level of optical transparency comprises an optically translucent or blurry level of optical transparency.

12. The wearable audio device of claim 1, wherein the one or more processors are configured to:
receive a user input via an interface indicating the level of optical transparency; and
control the signal to change the level of optical transparency of the smart material based on the user input.

13. The wearable audio device of claim 1, wherein the wearable audio device comprises headphones comprising one or more ear cups configured to enclose at least a portion of at least one ear of a wearer of the headphones, and wherein at least a portion of the one or more ear cups comprises the smart material.

14. A method of indicating an ability of a wearer of a wearable audio device to hear ambient noise to a non-wearer of the wearable audio device, comprising:
outputting a signal to control a level of optical transparency of a smart material of the wearable audio device, wherein the level of optical transparency of the smart material indicates the ability of the wearer of the wearable audio device to hear ambient noise.

15. The method of claim 14, wherein the smart material comprises smart glass, a smart acrylic, an electrochromic material, a thermochromic material, a photochromic material, a liquid crystal film, or a suspended particle film.

16. The method of claim 14, further comprising:
determining a listening state; and
controlling, based on the determined listening state, the signal to change the level of optical transparency of the smart material.

17. The method of claim 16, wherein the listening states comprises one of a plurality of listening states, and wherein the plurality of listening states are associated with different capabilities of a wearer of the wearable audio device to hear ambient sound.

18. The method of claim 16, wherein determining the listening state comprises determining the listening state based on at least one of: an active noise cancelation listening mode, a transparency listening mode, a passive listening mode, a mixed listening mode, a power on mode, a power off mode, an audio playing mode, an audio not playing mode, an audio paused mode, an audio muted mode, a volume level being above one or more thresholds, or a volume level being below one or more thresholds.

19. The method of claim 16, wherein controlling the signal comprises controlling the signal to change the level of optical transparency of the smart material to a higher level of optical transparency in response to determining the listening state associated with a higher capability of a wearer of the wearable audio device to hear ambient sound, and wherein the listening state associated with the higher capability of the wearable audio device to hear ambient sound is based on at least one of: a transparency listening mode, a passive listening mode, a mixed listening mode, a power off mode, an audio not playing mode, an audio paused mode, an audio muted mode, or a volume level being below one or more thresholds.

20. A computer readable medium comprising computer executable code, wherein the computer executable code comprises:
code for outputting a signal to control a level of optical transparency of a smart material of a wearable audio device, wherein the level of optical transparency of the smart material indicates an ability of a wearer of the wearable audio device to hear ambient noise.
